(19) United States
(12) Patent Application Publication
(10) Pub. No.: US 2020/0132885 A1
(43) Pub. Date: Apr. 30, 2020

(54) OPTICAL ELEMENT WITH ANTIREFLECTION STRUCTURE, MOLD FOR MANUFACTURING, METHOD OF MANUFACTURING OPTICAL ELEMENT WITH ANTIREFLECTION STRUCTURE, AND IMAGING APPARATUS

(71) Applicant: TAMRON CO., LTD., Saitama (JP)

(72) Inventors: Shunya FUKUI, Saitama (JP); Terufusa KUNISADA, Saitama (JP); Shigenori HOSOYA, Saitama (JP)

(73) Assignee: TAMRON CO., LTD., Saitama (JP)

(21) Appl. No.: 16/552,355

(22) Filed: Aug. 27, 2019

(30) Foreign Application Priority Data
Oct. 31, 2018 (JP) 2018-204820

(51) Int. Cl. G02B 1/118; B29D 11/00

(52) U.S. Cl. CPC G02B 1/118; G02B 3/00; B29D 11/0048

(57) ABSTRACT

There is provided an optical element with antireflection structure on at least a part of an optical effective surface. The optical element includes an outer peripheral wall surface that is substantially parallel to an optical axis at the entire outer periphery of at least one side of the optical effective surface toward the other side, and an annular plate portion that extends from the outer peripheral wall surface to the outside in a diameter direction perpendicular to the optical axis. The annular plate portion surrounds the entire outer periphery of the optical effective surface, and an outer peripheral front end includes a free end surface formed by causing an optical element glass material to flow.

### CROSS-REFERENCE TO RELATED APPLICATIONS

This application is based on and claims the benefit of priority from Japanese Patent Application No. 2018-204820, filed on Oct. 31, 2018, the entire contents of which are incorporated herein by reference.

### BACKGROUND OF THE INVENTION

### Technical Field

The present invention relates to an optical element with an antireflection structure for use in optical equipment, a mold for manufacturing the same, and a method of manufacturing an optical element with an antireflection structure.

### Related Art

There is a need for an optical element having high optical performance as a video technology is developed in recent years, and it is necessary to reduce a loss of transmission light generated by reflection of light incident on a surface of the optical element. Thus, surface processing is performed, for example, antireflection structure is formed on at least one surface of a light incidence surface and a light exist surface of an optical effective surface of the optical element.

In recent years, antireflection performance excellent for wavelength band characteristics and incident angle characteristics is realized by adopting a method of forming, as the antireflection structure, a fine irregularity structure of a use wavelength or less on the surface of the optical element and suppressing a rapid change of a refractive index. As disclosed in JP 2007-283581 A, a press molding method using a mold is widely used for forming the fine irregularity structure, and an optical element with an antireflection structure is produced.

When the optical element with an antireflection structure is assembled into various pieces of optical equipment, the optical element with an antireflection structure is used by being accurately assembled with a frame body such as a barrel. In this case, even though the optical effective surface of the optical element with an antireflection structure is manufactured with high accuracy, when the accuracy of the assembly is low, high optical performance is not acquired. In the assembly in this case, a method of using an adhesive as shown in FIG. 7A with an assembly surface formed on the optical element as a reference or a method of fixing the frame body by plastic deformation of a part of the frame body as shown in FIG. 7B is adopted. In general, the assembly surface formed on the optical element is formed by centering (grinding while rotating the optical element after an optical surface is held and a pose thereof is adjusted in a method called a bell clamp).

Meanwhile, a method of forming the assembly surface in which the centering is omitted is also suggested. For example, JP 2000-1322 A and JP 2007-91569 A disclose that a surplus material is escaped to a space or a chamfered portion formed at an adjacent portion of the optical effective surface by using the press molding using the mold and an outer diameter used as the assembly surface of the optical element with an antireflection structure is formed.

When the optical element with an antireflection structure including fine irregularities on the optical effective surface is manufactured in the press molding method using the mold, it is difficult to perform the centering afterwards. This is because it is difficult to control the pose thereof even though the optical effective surface is held by the bell clamp and the fine irregularities present, on the optical effective surface are destroyed.

Meanwhile, even though there is an attempt to acquire the optical element with an antireflection structure having an assembly surface shape by using the mold used in the press molding of the related art, the amount of a raw glass material that inevitably protrudes from a gap between blocks constituting the mold increases, and it necessary to perform the centering afterwards. This is because when the fine irregularities constituting the antireflection structure are formed by the press molding method, a long press time is required in order to form the fine irregularities compared to press molding of an optical element with no antireflection structure. Accordingly, when the fine irregularities are formed on the optical effective surface by the press molding method using the mold of the related art, an optical effective surface having a high-precision curvature and an assembly surface not requiring the centering afterwards are not able to be simultaneously formed during the press molding.

The problems common between JP 2007-283581 A, JP 2000-1322 A, and JP 2007-91569 A is that since the amount of the escaped raw glass material during the press molding is small, it is not possible to cope with the transfer of the fine irregularity structure. According to JP 2007-283581 A, JP 2000-1322 A, and JP 2007-91569 A, there are the following problems. In the invention disclosed in JP 2007-283581 A, since a variation in volume of the raw glass material and the escape of the surplus material are not considered, burrs inevitably occur on the assembly surface. Thus, it is difficult to accurately assemble the optical element with the frame body without performing the centering.

Meanwhile, even in the case of the press molding methods disclosed in JP 2000-1322 A and JP 2007-91569 A that suggest the method of forming the assembly surface in which the centering is omitted, there are problems that it is not possible to simultaneously form the optical effective surface having a high-precision curvature and the assembly surface not requiring the centering afterwards during the press molding.

In the case of the invention disclosed in. JP 2000-1322 A, since it is possible to form the outer diameter while considering the escape of the surplus material during the press molding but an arrangement position with respect to an optical axis is not clearly determined from a shape feature of a product to be manufactured, it is difficult to position the optical element with respect to another component when the optical element is assembled with the frame body.

In the case of the invention disclosed in JP 2007-91569 A, it is easy to arrange the optical element with respect to the optical axis, but protrusion portions are formed above and below a front end portion of a portion formed as a flat surface perpendicular to the optical axis so as to cause the surplus material during the press molding to flow. Accordingly, it is necessary to remove the protrusion portions by performing the centering afterwards, and thus, it is difficult to omit the centering.

An object of the present application is to provide an optical element with an antireflection structure obtained by a press molding method using a mold, the optical element with an antireflection structure including fine irregularities on an optical effective surface having a high-precision curvature and demonstrating favorable assembly performance for a frame body even though centering is not performed after press molding.

### SUMMARY OF THE INVENTION

In order to solve the above-described problems, an optical element with an antireflection structure, a mold to be used in manufacturing the same, and a method of manufacturing the same to be described below have been derived by conducting an intensive research.

A Optical Element with Antireflection Structure According to Present Application

An optical element with an antireflection structure according to the present application is an optical element including an antireflection structure on at least a part of an optical effective surface. The optical element includes an outer peripheral wall surface that is substantially parallel to an optical axis at the entire outer periphery of at least one side of the optical effective surface toward the other side, and an annular plate portion that extends from the outer peripheral wall surface to the outside in a diameter direction perpendicular to the optical axis. The annular plate portion surrounds the entire outer periphery of the optical effective surface, and an outer peripheral front end includes a free end surface formed by causing an optical element glass material to flow.

B. Mold for Manufacturing Optical Element with Antireflection Structure

A mold for manufacturing an optical element with an antireflection structure according to the present application is constituted by a pair of molds to be used for manufacturing the optical element with an antireflection structure. One first mold includes a first optical region forming surface for forming an optical effective surface on one surface of the optical element to be acquired, a first outer diameter restriction wall surface formed in parallel with an optical axis direction from an outer peripheral end of the first optical region forming surface, and a first horizontal restriction surface horizontally formed in a lens diameter direction perpendicular to the optical axis direction from a front end of the first outer diameter restriction wall surface. The other second mold includes a second optical region forming surface for forming an optical effective surface on the other surface of the optical element to be acquired and a second horizontal restriction surface horizontally formed in the lens diameter direction perpendicular to the optical axis direction of the second optical region forming surface. A fine irregularity shape for forming the antireflection structure is formed on at least one of the first optical region forming surface and the second optical region forming surface.

C. Method of Manufacturing Optical Element with Antireflection Structure

A method of manufacturing an optical element with an antireflection structure according to the present application is performed using the mold for manufacturing the optical element with an antireflection structure. The method includes arranging the first mold and the second mold so as to face each other, and sandwiching the raw glass material in a forming space of an effective optical region constituted by the first optical region forming surface of the first mold and the second optical region forming surface of the second mold, and forming the annular plate portion that surrounds the entire outer periphery of an optical effective surface and of which the front end is the free end surface by heating and softening the raw glass material, performing press molding until the first horizontal restriction surface of the first mold and the second horizontal restriction surface of the second mold are separated by 0.5 mm to 0.8 T mm, and causing the softened raw glass material to flow to and enter the gap between the first horizontal restriction surface and the second horizontal restriction surface.

D. Imaging Apparatus According to Present Application

An imaging apparatus according to the present application uses the optical element with an antireflection structure.

The optical element with antireflection structure according to the present application has favorable antireflection performance for the high-accuracy optical effective surface acquired by adopting the press molding method and includes the assembly surface without unnecessarily performing the centering afterwards. Since burrs generated by the entering of the softened and flowed raw glass material to the gap between the molds are not generated in the optical element with an antireflection structure, the assembly of the optical element with an antireflection structure with an imaging apparatus is easily performed with high accuracy. Accordingly, the imaging apparatus provided with the optical element with an antireflection structure according to the present application demonstrates favorable imaging performance. Since it is not necessary to perform the centering, the production cost of the optical element with an antireflection structure can be reduced, and is inexpensive.

It is not necessary to perform the centering on the optical element after the press molding by adopting the mold for manufacturing the optical element with an antireflection structure and the method of manufacturing the same, and it is possible to remarkably reduce the production cost.

### BRIEF DESCRIPTION OF THE DRAWINGS

FIG. 1 is a schematic cross-sectional view of an optical element with an antireflection structure according to the present application;

FIGS. 2A and 2B are schematic cross-sectional views of other forms of the optical element with an antireflection structure according to the present application;

FIG. 3 is a schematic cross-sectional view related to a mold according to the present application;

FIG. 4 is a schematic cross-sectional view for describing a concept of press molding;

FIG. 5 is a schematic cross-sectional view for describing the concept of the press molding;

FIG. 6 is a conceptual diagram for describing an “astigmatism amount” mentioned in the present application; and

FIGS. 7A and 7B are schematic diagrams showing an image of an assembly of an optical element with an antireflection structure of the related art with a frame body.

### DESCRIPTION OF THE EMBODIMENTS

Hereinafter, embodiments of an optical element, a mold to be used in manufacturing the same, and a method of manufacturing the same according to the present invention will be described.

A Form of Optical Element with Antireflection Structure

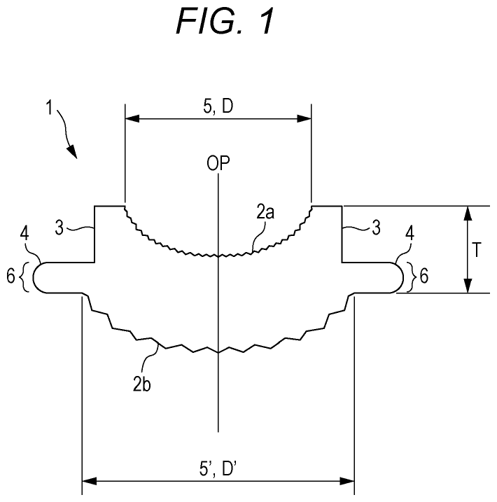

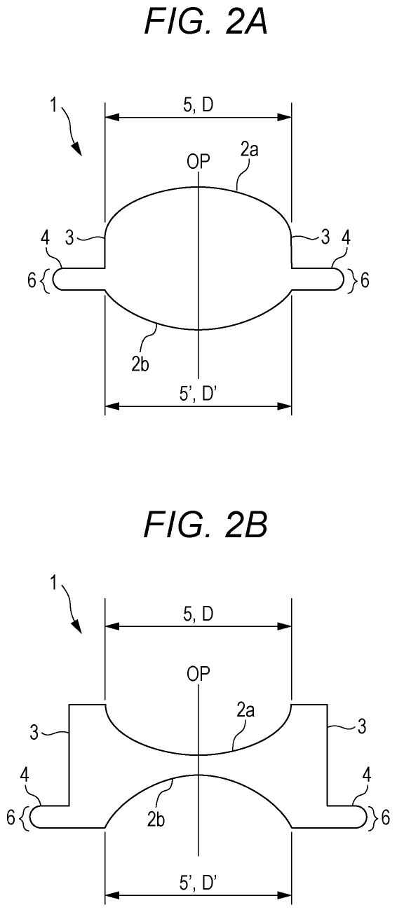

An optical element 1 with an antireflection structure according to the present application is an optical element including an antireflection structure on at least a part of an optical effective surface, and has a cross-section shape shown in FIG. 1. The optical element is not limited to the form shown in FIG. 1, and optical elements having various shapes of which optical effective surfaces are a flat surface, a spherical surface, an aspherical surface, and a free-form surface are used as targets. In FIG. 1, an image in which antireflection structures 2a and. 2b are formed on a double-sided optical effective surface 5 is shown. In FIGS. 2A and 2B, other forms of the optical element with an antireflection structure according to the present application are shown. Hereinafter, the optical element with an antireflection structure will be described with reference to FIG. 1.

(1) Configuration of Optical Element with Antireflection Structure

In the case of the optical element 1 with an antireflection structure according to the present application, an outer peripheral wall surface 3 substantially parallel to an optical axis is formed at the entire outer periphery of at least one side of the optical effective surface 5 toward the other side. An annular plate portion 4 extending from the outer peripheral wall surface 3 a diameter direction perpendicular to the optical axis is formed. Two surfaces of the “outer peripheral wall surface parallel to the optical axis” and the “annular plate portion. 4 perpendicular to the optical axis” described above may be collectively referred to as an “assembly surface” when the optical element is attached to a frame body. The assembly surface is present, and thus, assembly performance for the frame body is dramatically improved.

Outer peripheral wall surface: the outer peripheral wall surface of the optical element 1 with an antireflection structure according to the present application is formed as a wall surface substantially parallel to the optical axis at the outer periphery of at least one side of the optical effective surface 5 toward the other side, as can be seen from FIG. 1. It is preferable that a distance (hereinafter, referred to as an “outer peripheral wall surface height”) of the outer peripheral wail surface 3 in an optical axis direction in this case is 0.2 T mm to 0.81 mm. (1≥1) when a lens thickness 1mm to be described below is a reference. This is because the assembly performance for the frame body is declined and these surfaces do not function as the assembly surface when the outer peripheral wall surface height is less than 0.2 T mm. Meanwhile, when the distance of the outer peripheral wall surface 3 in the optical axis direction exceeds 0.8 T (T≥1) mm, since the assembly performance for the frame body is riot improved and a size reduction required for the optical element is not achieved, such a distance is not preferable.

As a thickness of the annular plate portion to be described below becomes greater than the distance of the outer peripheral wall surface, since a softened and flowed raw glass material during press molding flows to an outer periphery of the mold, it is difficult to transfer a height of a fine irregularity structure of the mold to the optical effective surface. Thus, such a distance is not preferable. Thus, it is preferable that the distance of the outer peripheral wall surface is equal to or greater than 0.21 mm,

Annular plate portion: this annular plate portion 4 surrounds the entire outer periphery of the optical effective surface and an outer peripheral front end thereof is formed without a shape restriction of a flowed optical element glass material during press processing. This front end is referred to as a free end surface 6. As for the annular plate portion 4, a distance from the outer peripheral wall surface 3 of the optical effective surface 5 to the free end surface 6 is referred to as a protrusion distance with an optical effective surface diameter D (diameter of the optical effective surface 5: represented as D mm when the diameter is represented as a value) as a reference.

It is preferable that this protrusion distance d is 0.5 mm≤d≤D mm. From a physical point of view, when the protrusion distance d is less than 0.5 mm, since the assembly performance for the frame body is not improved, this distance is not preferable. Meanwhile, when the protrusion distance d exceeds D mm, the protrusion distance d becomes excessive with respect to the optical effective surface diameter D, and the size reduction required for the optical element is not achieved. As a result, since there is no market demand, resources are wasted, and thus, this distance is not preferable. As in the optical element shown in FIG. 1, when optical effective surfaces are present on two front and rear surfaces, the optical effective surface 5 and the optical effective surface diameter D as targets are present on a side on which the outer peripheral wall surface 3 is formed. That is, in the case shown in FIG. 1, the “optical effective surface” is indicated by a reference numeral 5, and the “optical effective surface diameter” is indicated by a reference symbol D. Since the free end surface 6 is formed without the shape restriction of the flowed optical element glass material as described above (that is, the shape is not restricted by an inner wall surface of the mold), a distance (radius) from the optical axis to the free end surface 6 may not be constant. In such a case, when d is in a range of 0.5 mm≤d≤D mm as an average of the distance from the outer peripheral wall surface 3 to the free end surface 6 over the entire periphery, it is possible to acquire the aforementioned effects.

It is preferable that the annular plate portion 4 has a thickness of 0.5 mm to 0.81 mm with the lens thickness T as a reference. When the thickness of the annular plate portion 4 is less than 0.5 mm, since strength required for the assembly surface may be insufficient, this thickness is not preferable. Meanwhile, when the thickness of the annular plate portion 4 exceeds 0.81 mm, since it is not necessary to acquire excessive strength, the assembly performance for the frame body is also declined. Thus, this thickness is not preferable. The “lens thickness” mentioned herein is a combined thickness of the thickness of the outer peripheral wall surface 3 and the thickness of the free end surface 6 which is represented by a reference symbol “T” of the optical element 1 with an antireflection structure as shown in FIG. 1.

Constituent material: in the case of the optical element 1 with an antireflection structure according to the present application, all a glass material and a plastic material can be used without particular limitation as long as the material has a glass transition point capable of being formed by press molding.

Antireflection structure included in optical element: the antireflection structure includes fine irregularities in the optical element with an antireflection structure according to the present application. The shape of the fine irregularities is not particularly limited, but it is preferable that fine columnar protrusions are arranged with a periodicity which is equal to or less than a wavelength of a use average wavelength in order to arbitrarily control an antireflection effect. When the arrangement pitch of the fine columnar protrusions is equal to or less than a use average wavelength (A), it is possible to acquire a predetermined antireflection effect. It is more preferable that the arrangement pitch of the fine columnar protrusions is equal to or less than λ/2. This is because harmful light due to diffraction is likely to be generated when the arrangement pitch of the fine columnar protrusions exceeds λ/2. It is more preferable that this arrangement pitch is in a range of 0.2 λto 0.4 λ. When the arrangement pitch is less than 0.2 λ, the presence density of the fine columnar protrusions of the antireflection structure becomes excessively high, and thus, unnecessary diffracted light increases within the antireflection structure. As a result, since an antireflection effect excellent for wavelength band characteristics and incident angle characteristics cannot be acquired, this arrangement pitch is not preferable. Meanwhile, when the arrangement pitch exceeds 0.4 λ, the presence density of the fine columnar protrusions of the antireflection structure is excessively low, and thus, a sufficient antireflection effect is not acquired. Thus, this arrangement pitch is not preferable.

B. Mold for Manufacturing Optical Element with Antireflection Structure

A pair of molds to be used for manufacturing the optical element with an antireflection structure according to the present application can be greatly divided into a first mold and a second mold. In the following description, the first mold and the second mold are distinguishably described.

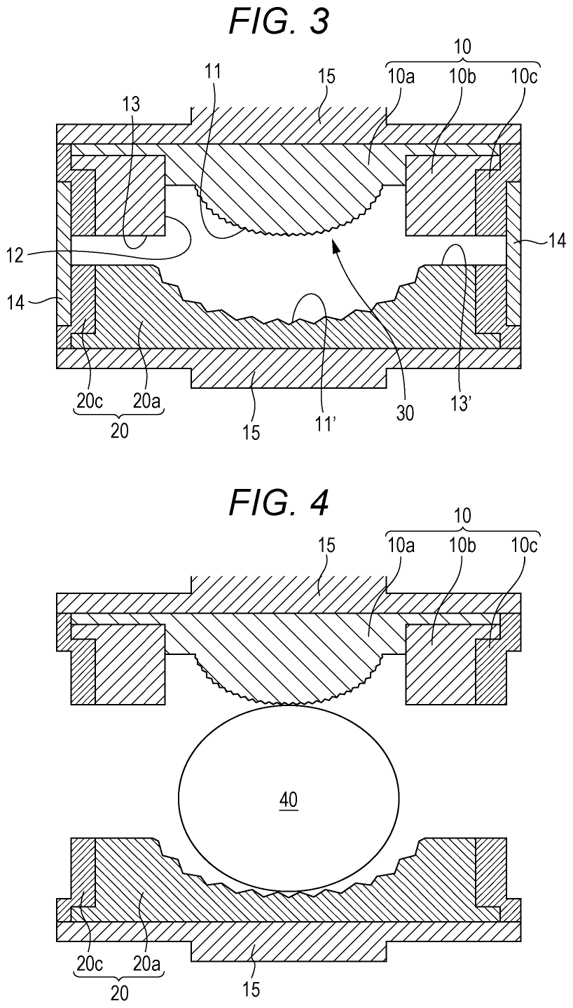

First mold: as can be seen from a schematic diagram shown. FIG. 3, this first mold. 10 includes a first optical region forming surface 11 for forming the optical effective surface 5 on one surface of the optical element with an ant-reflection structure to be acquired, a first outer diameter restriction wall surface 12 formed parallel to an optical axis OP from an outer peripheral end of the first optical region forming surface 11 toward the other side, and a first horizontal restriction surface 13 horizontally formed in a lens diameter direction 11) perpendicular to the optical axis OP from a front end of the first outer diameter restriction wall surface 12.

As can be seen from FIG. 3, the first mold 10 and the second mold 20 to be described below may be integrally formed or may be divided into a plurality of blocks. The first mold 10 shown in FIG. 3 is divided into the plurality of blocks of an optical effective surface mold 10a, an outer diameter restriction mold 10b, and an accommodation mold 10c. As can be seen from the image of the press molding, a positioning sleeve 14 and a press plate 15 are shown in FIG. 3.

It is preferable that a material of the first mold 10 is cemented carbide represented by tungsten carbide, cermet, silicon carbide, other ceramics, or heat-resistant metal. When the molds 10a and 10b are formed, it is preferable that the material of the mold 10b having a linear expansion coefficient smaller than a linear expansion coefficient of the material of the mold 10a is used. Accordingly, clearance between both the molds is secured at the normal temperature at which the molds are assembled, whereas the clearance is narrowed in a press molding temperature zone and burrs are less likely to be generated. It is preferable that a thickness of the mold 10 is at least 3 mm with consideration for mechanical strength.

Second mold: the second mold 20 shown in FIG. 3 includes a second optical region forming surface 11′ for forming an optical effective surface 5′ on the other surface of the optical element to be acquired, and a second horizontal restriction surface 13′ horizontally formed from an outer peripheral end of the second optical region forming surface 11′ in the lens diameter direction perpendicular to the optical axis direction. In FIG. 3, the second mold 20 divided into blocks of an optical effective surface mold 20a and an accommodation mold 20c are shown. In the case of the second mold 20, the outer diameter restriction mold 10b included in the first mold 10 is omitted. However, the outer diameter restriction mold can also be formed at the second mold 20. When the outer diameter restriction wall surfaces are formed on both the surfaces of the optical element in this manner, it is not necessary to distinguishably form the outer diameter restriction surfaces when the front and rear of the optical element is switched. When the same lens surface is formed on both the surfaces, it is not necessary to distinguish between the front and rear, and thus, handling is improved. The concept of the material and the minimum thickness is the same as that of the first mold 10, and the redundant description thereof will be omitted.

C. Form for Manufacturing Optical Element According to Present Application

The method of manufacturing the optical element according to the present application is to acquire the optical element by performing press molding using the mold for manufacturing the optical element with an antireflection structure.

As shown in FIG. 4, the first mold 10 and the second mold 20 are arranged so as to face each other, and a raw glass material is sandwiched between the first optical region forming surface 11 and the first outer diameter restriction wall surface 12 of the first mold 10 and the second optical region forming surface 11′ of the second mold 20. A raw glass material 40 is softened by being heated to a temperature of glass transition point or more.

Thereafter, a press state is maintained while pressing the molds until the first horizontal restriction surface 13 of the first mold 10 and the second horizontal restriction surface 13′ of the second mold are separated by 0.5 mm to 0.8 T mm (T≥1). As a result, the softened raw glass material enters a gap between the first horizontal restriction surface 13 and the second horizontal restriction surface 13′ of the molds, and the annular plate portion of which the front end is the free end surface can be formed at the entire outer periphery of the optical effective surface of the acquired optical element. A heating condition and a press pressure in this case are appropriately determined depending on the kind of the raw glass material.

D. Form of Imaging Apparatus According to Present Application

An imaging apparatus according to the present application uses the optical element with an antireflection structure. The imaging apparatus mentioned herein is not particularly limited. All imaging apparatuses such as digital cameras and video cameras requiring the antireflection effect are suitable.

### EXAMPLE 1

In Example 1, it was assumed that the use average wavelength λ=10 μm, and the double-sided meniscus lens shown in FIG. 1 was manufactured by using chalcogenide glass IRG 206 having a glass transition point of 180° C. as the glass material.

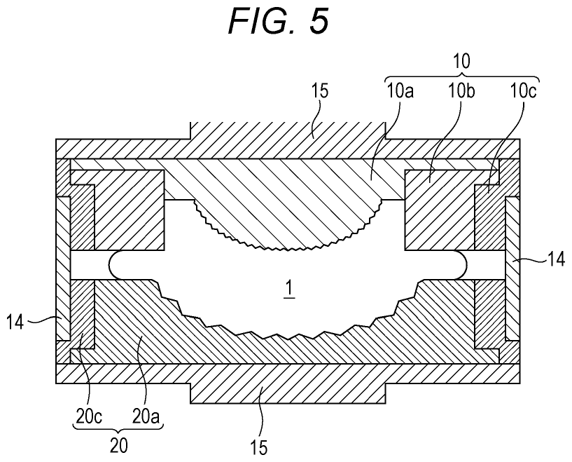

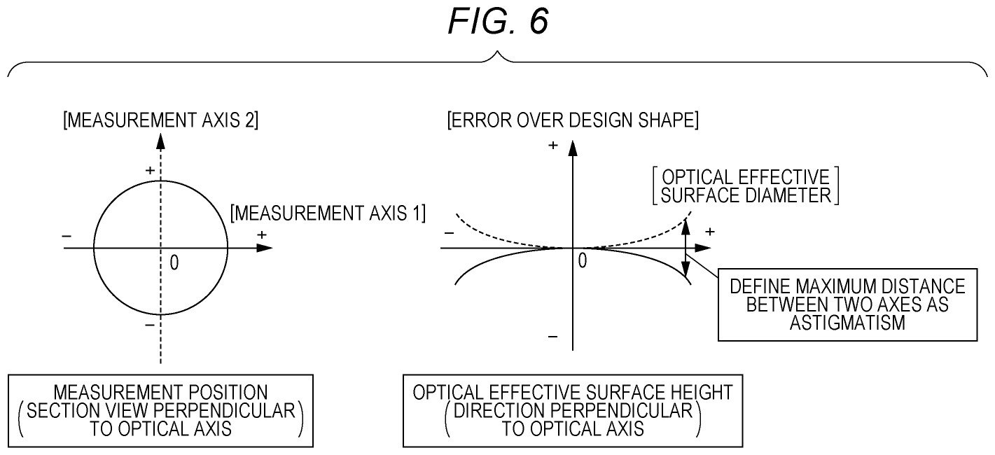

The press molding condition in this case is that glass material pellets were softened by retaining the glass material pellets for four minutes at 220° C. while being placed between the first mold 10 and the second mold 20 as shown in FIG. 5 by using the mold for manufacturing the optical element with an antireflection structure shown in FIG. 4. The outer diameter restriction mold for forming the first outer diameter restriction wall surface 12 in this case had an outer diameter of about 23.5 mm and an inner diameter of 14 mm. Thereafter, the optical element (double-sided meniscus lens) was manufactured simultaneously with the forming the antireflection structure on the optical effective surfaces 5 and 5′ by performing the press molding for five minutes with a press load of 500 N until a gap between the first horizontal restriction surface 13 of the first mold 10 and the second horizontal restriction surface 13′ of the second mold 20 is 2 mm and T is 3.7 mm, cooling the molds to 180° C. at a velocity of −12° C./min while applying the load, stopping the application of the load, and cooling the molds to a normal temperature.

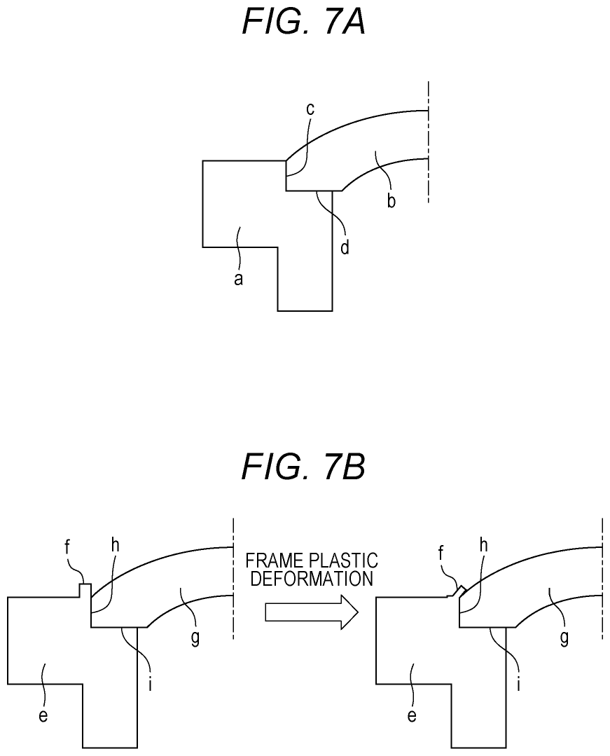

The antireflection structure included in the optical element 1 with an antireflection structure acquired in this manner is formed by transferring the fine irregularities formed on the optical region forming surfaces 11 and 11′ to the glass material during press molding. The fine columnar protrusions of which an arrangement pitch is 0.33 λ(3 μm) and an average height 2.9 μm were formed on the optical effective surface of the optical element by adopting such a transfer method. An astigmatism amount of the optical effective surface was an error of 0.2 or less in Newton conversion. As can be seen from explanatory diagrams shown in FIGS. 7A and 7B, the term of the “astigmatism amount” used in the present application refers to a “distance at which heights of two axes are most deviated when two axes running through within the optical effective surface are measured”.

Other specifications will be described. The optical element has an “outer peripheral wall surface diameter of 14 mm and an outer peripheral wall surface height of 3.7 mm” and has a “maximum value of an annular plate portion diameter of 18.8 mm and a thickness of 2 mm”. One optical effective surface 5 had a “diameter of 9.4 mm and a profile of an aspherical shape (hereinafter, referred to as “Sag amount”) of about 1 mm” and the other optical effective surface 5′ had a “diameter of 14.2 mm and a Sag amount of about 2.5 mm”.

The optical element 1 with an antireflection structure obtained as described above had no burrs caused by the flowed glass material between the outer peripheral wall surface and the annular plate portion as the assembly surface. Thus, it is not necessary to perform the centering.

### EXAMPLE 2

In Example 2, it was assumed that the use average wavelength λ=1.3 μm, and a biconvex lens shown in FIG. 7A was by using K-PG375 having a glass transition point of 344° C. as the glass material. In the diagram shown in FIG. 7A, positions at which the first outer diameter restriction wall surface 12 and the first horizontal restriction surface 13 of the first mold 10 are present and a position at which the second horizontal restriction surface 13′ of the second mold 20 is present are schematically shown.

In the press molding in this case, the glass material pellets were softened by retaining the glass material pellets for four minutes at 370° C. while being placed between the first mold 10 and the second mold 20 as shown in FIG. 5 by using the same mold for manufacturing the optical element with an antireflection structure shown in FIG. 4. The outer diameter restriction mold for forming the first outer diameter restriction wall surface 12 in this case had an outer diameter of about 38 mm and an inner diameter of 27 mm. Thereafter, the optical element (double-sided meniscus lens) was manufactured simultaneously with the forming the antireflection structure on the optical effective surfaces 5 and 5′ by performing the press molding for eight minutes with a press load of 4 kN until the gap between the first horizontal restriction surface 13 of the first mold 10 and the second horizontal restriction surface 13′ of the second mold 20 is 2 mm and T is 3.6 mm, cooling the molds to 288° C. at a velocity of −15° C./min while applying the load, stopping the application of the load, and cooling the molds to a normal temperature.

The antireflection structure included in the optical element 1 with as antireflection structure acquired in this manner is formed by transferring the fine irregularities formed on the optical region forming surfaces 11 and 11′ to the glass material during press molding. The fine columnar protrusions of which an arrangement pitch is 2.892 (0.45 μm) and an average height 0.5 μm were formed on the optical effective surface of the optical element by adopting such a transfer method. An astigmatism amount of the optical effective surface was an error of 0.2 or less in Newton conversion.

Other specifications will be described. The optical element has an “outer peripheral wall surface diameter of 27 mm and an outer peripheral wall surface height of 1.6 mm” and has a “maximum value of an annular plate portion diameter of 34 mm and a thickness of 2 mm”. One optical effective surface 5 had a “diameter of 27 mm and a “Sag amount” of about 2.4 mm” and the other optical effective surface 5′ had a “diameter of 27 mm and a Sag amount of about 2.2 mm”.

The optical element 1 with an antireflection structure obtained as described above had no burrs caused by the flowed glass material between the outer peripheral wall surface and the annular plate portion as the assembly surface. Thus, it is not necessary to perform the centering.

### EXAMPLE 3

In Example 3, it was assumed that the use average wavelength λ=1.3 μm, and a biconvex lens shown in FIG. 7B was by using K-PG325 having a glass transition point of 288° C. as the glass material.

In the press molding in this case, the glass material pellets were softened by retaining the glass material pellets for four minutes at 310° C. while being placed between the first mold 10 and the second mold 20 as shown in FIG. 5 by using the same mold for manufacturing the optical element with an antireflection structure shown in FIG. 4. The outer diameter restriction mold for forming the first outer diameter restriction wall surface 12 in this case had an outer diameter of about 23.5 mm and an inner diameter of 17 mm. Thereafter, the optical element (double-sided meniscus lens) was manufactured simultaneously with the forming the antireflection structure on the optical effective surfaces 5 and 5′ by performing the press molding for eight minutes with a press load of 4 kN until the gap between the first horizontal restriction surface 13 of the first mold 10 and the second horizontal restriction surface 13′ of the second mold 20 is 1.8 mm and T is 4.3 mm, cooling the molds to 288° C. at a velocity of −10° C./min while applying the load, stopping the application of the load, and cooling the molds to a normal temperature.

The antireflection structure included in the optical element 1 with an antireflection structure acquired in this manner is formed by transferring the fine irregularities formed on the optical region forming surfaces 11 and 11′ to the glass material during press molding. The fine columnar protrusions of which an arrangement pitch is 2.89 λ (0.45 μm) and an average height 0.48 μm were formed on the optical effective surface of the optical element by adopting such a transfer method. An astigmatism amount of the optical effective surface was an error of 0.2 or less in Newton conversion.

Other specifications will be described. The optical element has an “outer peripheral wall surface diameter of 17 mm and an outer peripheral wall surface height of 4.3 mm” and has a “maximum value of an annular plate portion diameter of 22 mm and a thickness of 1.8 mm”. One optical effective surface 5 had a “diameter of 12.6 mm and a Sag amount of about 0.7 mm” and the other optical effective surface 5′ had a “diameter of 14.8 mm and a Sag amount of about 0.7 mm”.

The optical element 1 with an antireflection structure obtained as described above had no burrs caused by the flowed glass material between the outer peripheral wall surface and the annular plate portion as the assembly surface. Thus, it is not necessary to perform the centering.

Although it has been described that the optical element with an antireflection structure according to the present application is obtained by adopting the press molding method, since it is not necessary to perform the centering after the press molding, it is possible to reduce the number of lens processing processes. Accordingly, a high-quality optical element is provided to the market at low cost, and thus, it is possible to contribute to a price reduction of the imaging apparatus. The mold to be used for manufacturing the optical element with an antireflection structure according to the present application can also be easily prepared, it is not necessary to provide a special apparatus at the time of performing the press molding. Thus, it is possible to effectively use a press molding facility of the related art, and it is not necessary to introduce a new facility.

What is claimed is:

1. An optical element with an antireflection structure on at least a part of an optical effective surface, the optical element comprising:
an outer peripheral wall surface that is substantially parallel to an optical axis at the entire outer periphery of at least one side of the optical effective surface toward the other side; and
an annular plate portion that extends from the outer peripheral wall surface to the outside in a diameter direction perpendicular to the optical axis,
wherein the annular plate portion surrounds the entire outer periphery of the optical effective surface, and an outer peripheral front end includes a free end surface formed by causing an optical element glass material to flow.

2. The optical element with an antireflection structure according to claim 1, wherein the annular plate portion has a protrusion distance d indicated by 0.5 mm≤d≤D mm from the outer peripheral wall surface of the optical effective surface with an optical effective surface diameter D mm as a reference.

3. The optical element with an antireflection structure according to claim 1, wherein, when a lens thickness T is a reference, the annular plate portion has a thickness of 0.5 mm to 0.8 T mm.

4. The optical element with an antireflection structure according to claim 1, wherein the free end surface is formed by performing press processing on a softened optical element glass material in a mold and causing the optical element glass material to flow.

5. The optical element with an antireflection structure according to claim 1, wherein the antireflection structure is formed such that an arrangement pitch of fine columnar protrusions of fine irregularities is 180 nm to 3500 nm.

6. A mold for manufacturing an optical element with an antireflection structure which is constituted by a pair of molds to be used for manufacturing the optical element with an antireflection structure according to claim 1,
wherein a first mold includes a first optical region forming surface for forming an optical effective surface on one surface of the optical element to be acquired, a first outer diameter restriction wall surface formed in parallel with an optical axis direction from an outer peripheral end of the first optical region forming surface, and a first horizontal restriction surface horizontally formed in a lens diameter direction perpendicular to the optical axis direction from a front end of the first outer diameter restriction wall surface,
the second mold includes a second optical region forming surface for forming an optical effective surface on the other surface of the optical element to be acquired and a second horizontal restriction surface horizontally formed in the lens diameter direction perpendicular to the optical axis direction of the second optical region forming surface, and
a fine irregularity shape for forming the antireflection structure is formed on at least one of the first optical region forming surface and the second optical region forming surface.

7. A method of manufacturing an optical element with an antireflection structure using the mold for manufacturing the optical element with an antireflection structure according to claim 6, the method comprising:
arranging the first mold and the second mold so as to face each other, and sandwiching the raw glass material in a forming space of an effective optical region constituted by the first optical region forming surface of the first mold and the second optical region forming surface of the second mold; and
forming the annular plate portion that surrounds the entire outer periphery of an optical effective surface and of which the front end is the free end surface by heating and softening the raw glass material, performing press molding until the first horizontal restriction surface of the first mold and the second horizontal restriction surface of the second mold are separated by 0.5 mm to 0.8 T mm, and causing the softened raw glass material to flow to and enter the gap between the first horizontal restriction surface and the second horizontal restriction surface.

8. An imaging apparatus using the optical element with an antireflection structure according to claim 1.
